(19) United States
(12) Patent Application Publication
(10) Pub. No.: US 2026/0054920 A1
(43) Pub. Date: Feb. 26, 2026

(54) Wall-Mounted Pet Waste Bag Dispenser with Increased Storage Capacity and Efficient Core Removal System

(71) Applicant: Daniel Lemus, Orlando, FL (US)

(72) Inventor: Daniel Lemus, Orlando, FL (US)

(21) Appl. No.: 18/813,020

(22) Filed: Aug. 23, 2024

(51) Int. Cl. B65F 1/14

(52) U.S. Cl. CPC B65F 1/1426

(57) ABSTRACT

A wall-mounted pet waste bag dispenser comprising a hollow body defining an interior space and a dispensing opening. The body, formed of a lightweight and durable plastic material, includes a plurality of ribs disposed in a lower portion of the interior space to support multiple rolls of pet waste bags and prevent jamming during dispensing. A plurality of stoppers in an upper portion of the interior space prevent the rolls from falling forward out of the body. The dispenser incorporates a core removal system comprising a plurality of apertures disposed on an end of the body, allowing empty roll cores to be easily pushed out. The interior space accommodates up to four standard-size rolls, and the dispenser includes a hingedly attached lid, an oval-shaped aperture for easy bag dispensing, and a versatile mounting system.

### BACKGROUND OF THE INVENTION

### Field of Invention

The present disclosure relates to the field of pet waste management devices, particularly to wall-mounted dispensers for storing and dispensing pet waste bags.

### Description of Prior Art

Various types of pet waste bag dispensers and holders are known in the art, including portable dispensers that can be attached to a leash or carried by the user, as well as stationary dispensers that can be mounted on a wall or other surface. These existing solutions aim to provide pet owners with convenient access to waste bags for cleaning up after their pets.

However, conventional pet waste bag dispensers suffer from certain limitations in terms of capacity, ease of use, and efficient management of bag rolls. Many portable dispensers are limited to holding a single roll of bags, requiring frequent refills. Wall-mounted dispensers often have a bulky design that protrudes from the wall and may not effectively contain and dispense multiple rolls of bags. Additionally, removing empty roll cores from these dispensers can be cumbersome, typically requiring the user to open the dispenser and manually extract the cores.

Accordingly, there is a need for an improved wall-mounted pet waste bag dispenser that offers increased storage capacity, convenient dispensing, and efficient management of bag rolls and empty cores, while maintaining a compact and unobtrusive design.

### BRIEF SUMMARY OF THE INVENTION

This summary is provided to introduce a selection of concepts, in a simplified format, that are further described in the detailed description of the invention. This summary is neither intended to identify key or essential inventive concepts of the invention nor is it intended for determining the scope of the invention.

The present disclosure provides a wall-mounted pet waste bag dispenser that offers improved storage capacity, convenient dispensing, and efficient management of bag rolls and empty cores. In one aspect, the dispenser comprises a hollow body defining an interior space and having a dispensing opening. The body is formed of a lightweight and durable plastic material, such as acrylonitrile butadiene styrene (ABS), providing a sturdy structure suitable for indoor and outdoor use.

A plurality of ribs are disposed in a lower portion of the interior space, configured to support multiple rolls of pet waste bags and prevent excessive movement or jamming of the bottom-most roll during dispensing. The dispenser further includes a plurality of stoppers in the form of inwardly protruding tabs in an upper portion of the interior space, which prevent the rolls from falling forward out of the body.

Advantageously, the dispenser incorporates a core removal system comprising a plurality of apertures disposed on an end of the body. These apertures are sized to allow empty roll cores to be easily pushed out of the dispenser, eliminating the need to manually remove them by opening the dispenser.

In a preferred embodiment, the dispenser includes a hingedly attached lid that can be moved between an open position for accessing the interior space and a closed position covering the dispensing opening. The interior space is sized to accommodate up to four standard-size rolls of pet waste bags, providing ample storage capacity and reducing refill frequency.

The dispenser may further comprise an oval-shaped aperture on the front face near the dispensing opening, allowing users to grasp and pull the leading edge of a bag for easy dispensing. A versatile mounting system, including screw holes and double-sided adhesive tape, enables the dispenser to be securely attached to a wall using either permanent or non-damaging installation methods.

The present invention addresses the limitations of existing pet waste bag dispensers by offering a compact, wall-mounted solution with increased storage capacity, efficient roll management, and user-friendly features. By incorporating a durable construction, space-saving design, and convenient core removal system, the dispenser improves upon prior art and provides pet owners with a superior option for storing and dispensing pet waste bags.

Additional features and advantages of the invention will be set forth in the description which follows. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 provides a perspective view of the wall-mounted pet waste bag dispenser, illustrating its key features such as the hollow body, stoppers, core removal apertures, and dispensing opening, according to one embodiment of the present invention.

FIG. 2 offers a lateral perspective view of the dispenser, focusing on the internal structure and components that ensure smooth dispensing and prevent jamming, according to one embodiment of the present invention.

FIG. 3 presents a bottom perspective view of the dispenser, highlighting the mounting system and design features that promote easy installation and prevent warping, according to one embodiment of the present invention.

FIG. 4 provides a top view of the lid component, which is designed to cover and protect the interior space of the dispenser, according to one embodiment of the present invention.

FIG. 5 offers a bottom view of the dispenser lid, revealing securing tabs that protrude downward along the perimeter, according to one embodiment of the present invention.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

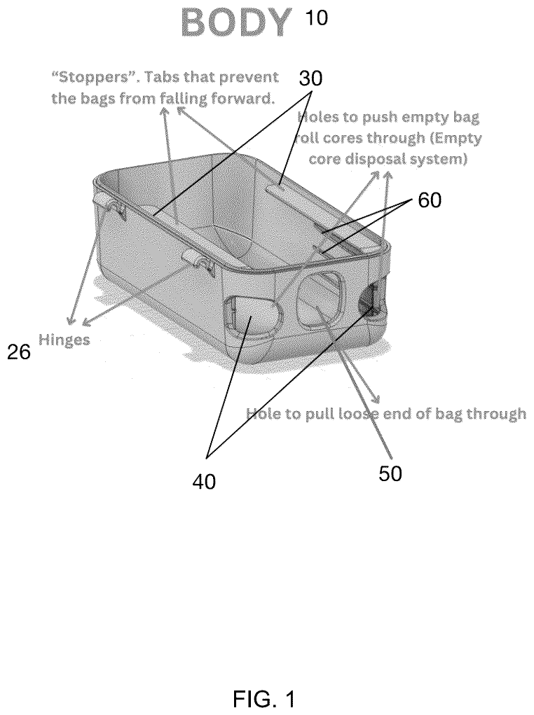

FIG. 1 illustrates a perspective view of an embodiment of a wall-mounted pet waste bag dispenser, which provides a convenient and efficient solution for storing and dispensing multiple rolls of pet waste bags in residential settings. The dispenser comprises a hollow body (10) that defines an interior space for accommodating the rolls and incorporates several key features to enhance functionality and user experience.

In one embodiment, the body (10) is formed of a lightweight and durable plastic material, preferably acrylonitrile butadiene styrene (ABS), with a wall thickness of approximately 3 mm. This construction ensures that the dispenser is sturdy enough for repeated use while remaining lightweight for easy installation. The choice of ABS plastic also renders the dispenser suitable for both indoor and outdoor environments.

As shown in FIG. 1, the body (10) has a generally rectangular cross-section with rounded corners and flat surfaces on its back and bottom sides. These flat surfaces allow the dispenser to be mounted flush against a wall and rest securely on a floor or shelf. The interior space is configured to accommodate up to four standard-size rolls of pet waste bags, thereby providing ample storage capacity and reducing the frequency of refills.

In the lower portion of the interior space, a plurality of parallel and evenly spaced ribs (60) are disposed on the bottom surface to support the rolls and prevent excessive movement of the bottom-most roll during use. These ribs help to ensure smooth dispensing of bags and minimize the risk of jamming.

With reference to FIG. 1, the upper portion of the interior space features a plurality of stoppers or tabs (30) that protrude inwardly from the walls. The stoppers (30) are integrally formed with the body (10) and serve to prevent the rolls from falling forward out of the dispensing opening when the dispenser is in use

As depicted in FIG. 1, one end of the body (10) includes a plurality of circular apertures (40) that form a core removal system. These apertures (40) are sized to allow empty roll cores to be pushed through for easy removal, thereby eliminating the need to open the dispenser's lid to dispose of empty cores.

The front face of the body (10) features a dispensing opening, which is an oval-shaped aperture (50) positioned near the bottom. This oval-shaped aperture (50) enables users to grasp and pull the leading edge of a bag through for dispensing, providing easy access to the pet waste bags.

In another embodiment, the dispenser includes a mounting system that offers two options to facilitate wall mounting. The first option involves a plurality of screw holes (12) for receiving screws, allowing the body (10) to be securely attached to a wall. Alternatively, the second option utilizes double-sided adhesive tape (not shown), which provides a non-damaging installation alternative for users who prefer not to drill into their walls.

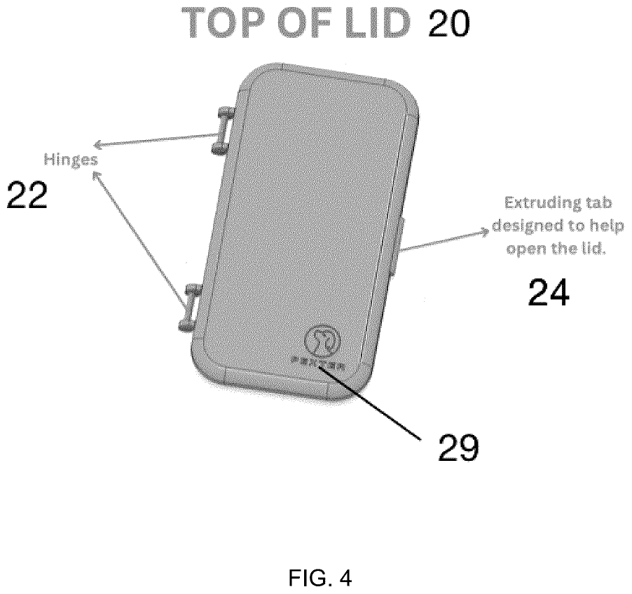

The dispenser also comprises a lid that is hingedly coupled to the body (10) (depicted in FIG. 4). The lid is movable between an open position, which allows access to the interior space for refilling the rolls, and a closed position that covers the dispensing opening to protect the bags from dust and moisture.

In summary, the wall-mounted pet waste bag dispenser illustrated in FIG. 1 provides a practical and user-friendly solution for pet owners to store and dispense multiple rolls of waste bags. The combination of its durable construction, space-saving design, and innovative features, such as the core removal system and flexible mounting options, sets this dispenser apart as a convenient and efficient tool for managing pet waste in various residential settings.

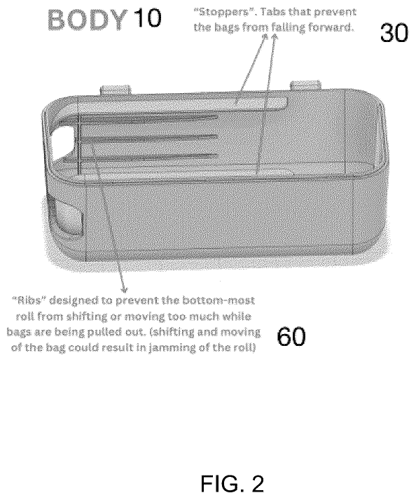

As depicted in FIG. 2, the wall-mounted pet waste bag dispenser provides a lateral perspective view, focusing on the internal structure and key components that facilitate smooth dispensing and prevent jamming. In one embodiment, the dispenser body (10), formed of lightweight and durable ABS plastic, is configured to accommodate up to four standard-size rolls of pet waste bags within its interior space.

The lower portion of the interior space features a series of parallel and evenly spaced ribs (60). These ribs are configured to support the rolls and prevent excessive movement of the bottom-most roll during the dispensing process. By minimizing roll shifting, the ribs are thereby able to ensure consistent and uninterrupted dispensing of individual bags, reducing the likelihood of jamming or tearing.

As further depicted in FIG. 2, the upper portion of the interior space comprises the plurality of stoppers or tabs (30) that protrude inwardly from the walls of the dispenser body (10). The stoppers (30), which are integrally formed with the body, are strategically positioned to prevent the rolls from falling forward out of the dispensing opening (50) when the dispenser is in use.

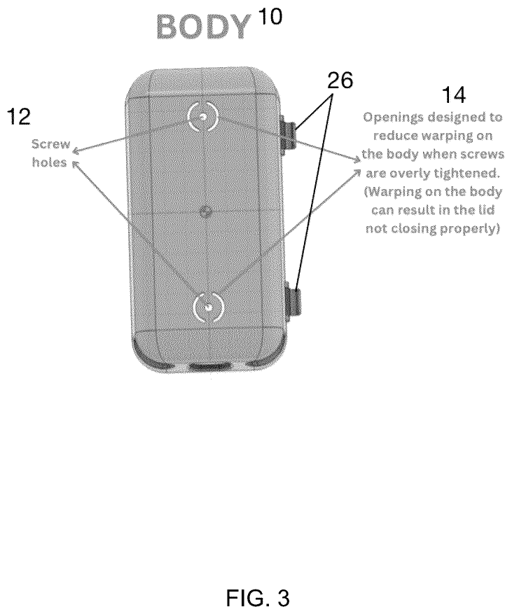

With reference to FIG. 3, a bottom perspective view of the wall-mounted pet waste bag dispenser is offered, highlighting the mounting system and design features that promote easy installation and prevent warping of the dispenser body (10).

In one embodiment, the front face of the dispenser body (10) includes two circular screw holes (12), one positioned near the top and the other near the bottom. These screw holes (12) are configured to receive screws, enabling the dispenser to be securely coupled to a wall for stable and reliable mounting.

Surrounding each screw hole (12) is a larger circular cut-out or opening (14). The openings (14) are configured to serve a critical purpose in preventing warping of the dispenser body (10) when the mounting screws are overtightened. Overtightening of the screws can lead to deformation of the body, which may result in misalignment of the lid and prevent proper closure. By providing a buffer zone around the screw holes, these openings (14) are thereby able to distribute the stress and minimize the risk of warping, ensuring that the lid maintains its proper fit and functionality.

According to an embodiment, the mounting system of the pet waste bag dispenser offers versatility and adaptability to suit different user preferences and wall surfaces. Alternatively to the screw holes, the dispenser can also be installed using double-sided adhesive tape (not shown). This alternative mounting option allows users to securely attach the dispenser to a wall without the need for drilling or causing permanent damage to the surface. The flexibility of the mounting system makes the dispenser suitable for a wide range of residential settings and accommodates various user needs.

As shown in FIG. 4, a top view of the lid component (20) of the pet waste bag dispenser is provided. In one embodiment, the lid (20) is configured to cover and protect the interior space of the dispenser body (10) when in the closed position. The lid (20) is preferably formed of the same lightweight and durable ABS plastic material as the body (10) to ensure compatibility and longevity. In one embodiment, the lid (20) has a generally rectangular shape with rounded corners, mimicking the contours of the dispenser body (10).

Attached to the left side of the lid (20) are two cylindrical hinges (22) that allow the lid to pivot between the open and closed positions. These hinges (22) are integrally formed with the lid (20) and are configured to engage with corresponding hinge receptacles (26) (as depicted in FIG. 1) on the dispenser body (10). The hinges (22) are positioned symmetrically along the left edge of the lid (20) to ensure a balanced and smooth opening and closing motion.

On the right side of the lid (20), opposite the hinges (22), is an extruding tab (24) configured to facilitate easy opening of the dispenser. This tab (24) protrudes slightly from the edge of the lid (20) and features a textured or ribbed surface to provide a secure grip for the user's fingers. By grasping the extruding tab (24) and applying upward pressure, the user can easily pivot the lid (20) to the open position, thereby allowing access to the interior space of the dispenser for refilling or maintenance purposes.

Embossed or engraved into the center of the lid's (20) top surface is a logo (29) that serves to identify the brand and enhance the aesthetic appeal of the dispenser. The logo (29) depicts a stylized representation of a dog or animal figure, accompanied by the text “PEXTEP,” which is likely the brand name of the product. The inclusion of this branding element helps to create a cohesive and recognizable product identity.

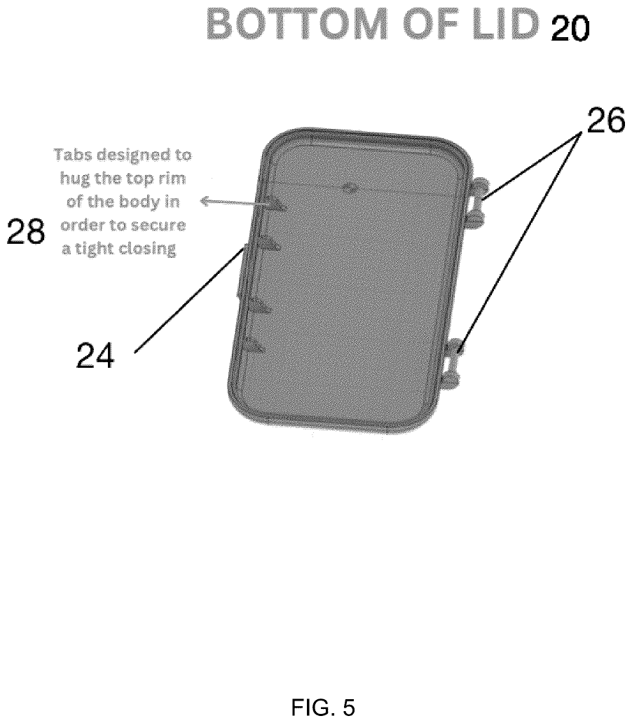

With reference to FIG. 5, a bottom view of the dispenser lid (20) is offered, revealing additional features that contribute to its functionality and secure attachment to the dispenser body (10). In one embodiment, the underside of the lid (20) includes multiple securing tabs (28) that protrude downward along the perimeter. These tabs (28) are configured to engage with the top rim of the dispenser body (10) when the lid (20) is in the closed position, thereby creating a tight and secure closure that prevents accidental opening or spillage of the contents.

The securing tabs (28) are integrally formed with the lid (20) and are spaced evenly along the edge with the extruding tab (24) to ensure a uniform distribution of pressure when the lid is closed. The tabs (28) are slightly angled inward to create a snap-fit engagement with the dispenser body (10), providing tactile feedback to the user when the lid (20) is properly closed.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A wall-mounted pet waste bag dispenser, comprising:
a hollow body defining an interior space and having a dispensing opening, the body being formed of a lightweight and durable plastic material;
a plurality of ribs disposed in a lower portion of the interior space, the ribs being configured to support a plurality of rolls of pet waste bags and prevent excessive movement of a bottom-most roll during use;
a plurality of stoppers disposed in an upper portion of the interior space, the stoppers being configured to prevent the rolls from falling forward out of the body; and a plurality of apertures disposed on an end of the body, the apertures being configured to allow empty roll cores to be pushed therethrough for removal.

2. The wall-mounted pet waste bag dispenser according to claim 1, further comprising a lid hingedly attached to the body, the lid being movable between an open position allowing access to the interior space and a closed position covering the dispensing opening.

3. The wall-mounted pet waste bag dispenser according to claim 1, wherein the body is formed of acrylonitrile butadiene styrene (ABS) plastic having a thickness of approximately 3 mm, providing a lightweight and durable structure suitable for indoor and outdoor use.

4. The wall-mounted pet waste bag dispenser according to claim 1, wherein the plurality of ribs are parallel and evenly spaced, the ribs being configured to support the plurality of rolls and prevent jamming of a bottom-most roll during dispensing of bags.

5. The wall-mounted pet waste bag dispenser according to claim 1, wherein the plurality of stoppers are tabs integrally formed with the body and protruding inwardly from an upper portion of the interior space, the stoppers being positioned to prevent the rolls from falling forward out of the dispensing opening.

6. The wall-mounted pet waste bag dispenser according to claim 1, wherein the interior space is sized to accommodate up to four standard-size rolls of pet waste bags, providing ample storage capacity and reducing the frequency of refills.

7. The wall-mounted pet waste bag dispenser according to claim 1, further comprising mounting means for securing the body to a wall, the mounting means including a plurality of screw holes for receiving screws and a double-sided adhesive tape, providing options for permanent or non-damaging installation.

8. The wall-mounted pet waste bag dispenser according to claim 1, further comprising an oval-shaped aperture disposed on a front face of the body near the dispensing opening, the oval-shaped aperture being configured to allow a user to grasp and pull a leading edge of a bag therethrough for dispensing.

9. The wall-mounted pet waste bag dispenser according to claim 1, wherein the plurality of apertures on the end of the body are circular and sized to allow standard empty roll cores to be pushed therethrough, providing a convenient means for removing empty cores without opening the lid.

10. The wall-mounted pet waste bag dispenser according to claim 1, wherein the body has a rectangular cross-section with rounded corners and flat surfaces on a back side and a bottom side, the flat surfaces being configured to abut a wall and a floor, respectively, when the dispenser is mounted.

11. A dispenser for storing and dispensing pet waste bags, the dispenser comprising:
a container defining an interior cavity and having a front face with a dispensing opening, the container being adapted for mounting to a wall;
a storage compartment disposed in the interior cavity and configured to accommodate a plurality of vertically stacked rolls of pet waste bags;
a core removal system comprising a plurality of circular openings on an end of the container, the openings being sized and positioned to enable empty cores of the rolls to be pushed out of the container; and
a mounting system for attaching the container to the wall, the mounting system including a first option using screws and a second option using double-sided adhesive tape.

12. The dispenser according to claim 11, wherein the container is constructed from molded ABS plastic material having a thickness of approximately 3 mm, providing a lightweight yet durable structure suitable for indoor and outdoor use.

13. The dispenser according to claim 11, further comprising a lid hingedly attached to one longitudinal side of the container, the lid being pivotable between an open position allowing access to the storage compartment and a closed position covering the storage compartment.

14. The dispenser according to claim 11, further comprising a plurality of stoppers protruding from inner walls of the container near a top edge, the stoppers being configured to prevent the rolls of pet waste bags from falling forward within the container.

15. The dispenser according to claim 11, wherein the circular openings of the core removal system are positioned on a bottom end of the container, enabling empty cores to be pushed downwardly out of the container.

16. The dispenser according to claim 11, further comprising a dispensing aperture situated on the front face of the container near a bottom edge, the dispensing aperture being sized and shaped to allow a loose end of a pet waste bag to be pulled therethrough for dispensing.

17. The dispenser according to claim 11, wherein the mounting system further includes a plurality of flat surfaces on a back side and a bottom side of the container, the flat surfaces facilitating attachment of the container to the wall using the screws or the double-sided adhesive tape.

18. The dispenser according to claim 11, wherein the interior cavity is sized and configured to accommodate up to four standard-size rolls of pet waste bags, providing ample storage capacity for extended use.

19. The dispenser according to claim 11, further comprising a plurality of parallel ribs disposed in a lower portion of the interior cavity, the ribs being configured to prevent a bottom-most roll of pet waste bags from shifting excessively during dispensing, thereby mitigating jamming of the roll.

20. The dispenser according to claim 11, wherein the container has a rectangular cross-section with rounded corners, and is proportioned to discreetly store multiple rolls of pet waste bags while occupying minimal space when mounted to the wall.
